(19) United States
(12) Patent Application Publication
(10) Pub. No.: US 2013/0101831 A1
(43) Pub. Date: Apr. 25, 2013

(54) METALLIZED PAPER PACKAGING FILM AND PROCESS FOR ITS PRODUCTION

(71) Applicants: Anthony Robert KNOERZER, Parker, TX (US); Kenneth Scott LAVERDURE, Plano, TX (US); Todd Michael FAYNE, Dallas, TX (US)

(72) Inventors: Anthony Robert KNOERZER, Parker, TX (US); Kenneth Scott LAVERDURE, Plano, TX (US); Todd Michael FAYNE, Dallas, TX (US)

(73) Assignee: FRITO-LAY NORTH AMERICA, INC., Plano, TX (US)

(21) Appl. No.: 13/277,974

(22) Filed: Oct. 20, 2011

(51) Int. Cl. B32B 29/04; B32B 27/00; B32B 27/10; B32B 29/00

(52) U.S. Cl. 428/324; 428/537.5; 428/446; 428/537.7; 428/511; 427/326

(57) ABSTRACT

A multi-layer paper-based packaging material is provided that has adequate barrier properties. At least one surface of the paper is smoothed and then a barrier layer is applied. The paper can also include optional primer and heat-seal layers.

### BACKGROUND OF THE INVENTION

1. Technical Field

The present invention relates to a paper-based flexible packaging material having acceptable barrier properties for packaging food products and to a method of making such material.

2. Description of Related Art

Multi-layered film structures made from petroleum-based products originating from fossil fuels are often used in flexible packages where there is a need for its advantageous barrier, sealant, and graphics-capability properties. Barrier properties in one or more layers are important in order to protect the product inside the package from light, oxygen or moisture. Such a need exists, for example, for the protection of foodstuffs, which may run the risk of flavor loss, staling, or spoilage if insufficient barrier properties are present to prevent transmission of such things as light, oxygen, or moisture into the package.

Packaging films used in the prior art typically comprise layers of petroleum-based resin sheets, such as oriented polypropylene (“OPP”) or polyethylene terephthalate (“PET”). When the resin films do not provide adequate barrier properties, a barrier layer can be disposed on the surface of one of the inner layers of the multi-layer film. For example, a metal layer disposed upon an inner base layer can provide the required barrier properties. It has been found and is well known in the prior art that metalizing a petroleum-based polyolefin such as OPP or PET reduces the moisture and oxygen transmission through the film by approximately three orders of magnitude.

Petroleum-based prior art flexible films comprise a relatively small part of the waste produced when compared to other types of packaging. Thus, it is uneconomical to recycle because of the energy required to collect, separate, and clean the used flexible film packages. Further, because the petroleum films are environmentally stable, petroleum based films have a relatively low rate of degradation. Consequently, discarded packages that become inadvertently dislocated from intended waste streams can appear as unsightly litter for a relatively long period of time. Further, such films can survive for long periods of time in a landfill. Another disadvantage of petroleum-based films is that they are made from oil, which many consider to be a limited, non-renewable resource. Consequently, a need exists for a flexible packaging film made from a renewable resource, but which still has the desirable barrier properties of prior art petroleum-based packaging films. Such flexible film should be food safe and have the requisite barrier properties to store a low moisture shelf-stable food for an extended period of time without the product staling. The film should have the requisite sealable and coefficient of friction properties that enable it to be used on existing vertical form, fill, and seal machines.

### SUMMARY OF THE INVENTION

One embodiment of the present invention is directed towards a paper-based composite film and method for making a paper-based composite film comprising an outer paper layer having a smooth surface, an optional primer layer on said smooth surface, a barrier layer on said smooth surface, and an optional heat-seal layer on said barrier layer.

The above as well as additional features and advantages of the present invention will become apparent in the following written detailed description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts a magnified schematic cross-section of a multi-layer packaging film made according to one embodiment of the invention.

### DETAILED DESCRIPTION

The present invention is thus directed to a flexible packaging film comprising a barrier layer applied to a paper layer. The invention is also directed to a flexible food package utilizing the paper-based film. Heretofore, paper has never provided moisture and oxygen barrier properties sufficient to allow it to be used as a packaging material for long-term storage of low-moisture, shelf-stable snack products.

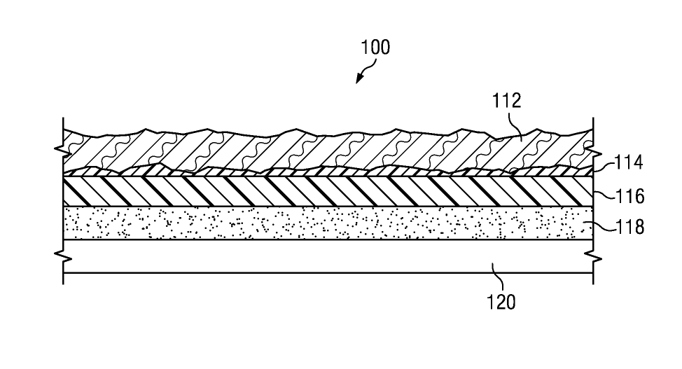

FIG. 1 is a magnified cross section of the paper-based packaging film 100 of one embodiment of the present invention. As shown therein, a paper layer 112 is coated on one side by a filler layer 114. The filler layer may have an optional primer layer 116 on the side opposite the paper layer 112. The film further comprises a barrier layer 118 on the side of the film opposite the paper layer 112. Optionally, a heat seal layer 120 is provided on the side of the barrier layer 118 opposite the paper layer 112. In other words, when a heat seal layer 120 is applied, the paper layer 112 will be the outermost layer and the heat seal layer 120 will be the innermost layer.

As used herein, a barrier layer 118 comprises a metal, metal oxide, metalloid oxide, and combinations thereof. Barrier layers 118 described herein can be applied by any suitable method known in the art, including, but not limited to evaporation, sputtering, chemical vapor deposition, combustion chemical vapor deposition, physical vapor deposition, plasma deposition, plasma enhanced chemical vapor deposition, vacuum deposition, flame deposition, and flame hydrolysis deposition. Coating technologies may also be used to apply a polymer barrier layer, such as polyvinylidene chloride (PVDC), EVOH, PVOH or acrylics. As used herein, a packaging film 100 that has acceptable barrier properties has both acceptable oxygen barrier properties and moisture barrier properties. As used herein, a packaging film 100 having acceptable oxygen barrier properties has an oxygen transmission rate of less than about 10 cc/m²/day (ASTM D-3985). As used herein, a packaging film 100 having acceptable moisture barrier properties comprises a water vapor transmission rate of less than about 0.5 grams/m²/day (ASTM F-1249).

In order for the packaging film to provide acceptable barrier properties, the barrier layer must be applied to a smooth surface of the paper. The problems encountered by a practitioner attempting to apply a barrier layer to a paper sheet result from the structure of the paper itself. During the paper manufacturing process, individual fibers (typically made of plant-based materials) are pressed together and dried to form flexible sheets of paper. When the surface topology of a sheet of paper is analyzed using a sensitive or high-magnification measuring device, such as an atomic force microscope, the “mesh” structure of the fibers can be clearly seen. The fibers can be seen as peaks or plateaus, and the space between the fibers can be seen as valleys or canyons.

Previously, when one skilled in the art has attempted to apply a barrier layer to a sheet of paper, the barrier layer has not provided acceptable barrier properties. This failure is primarily due to the high surface roughness—or difference in height between the peaks and valleys of the mesh structure—which causes the barrier particles to build up on the peaks, and shield the valleys from being coated with the barrier particles. Thus, while some barrier particles may adhere to the valley portions of the paper surface, it is extremely difficult to obtain adequate, continuous coverage between the peaks and valleys to provide acceptable barrier properties. This problem is especially acute when the height difference between the peaks and valleys, or the distance between adjacent peaks, is greater than the desired thickness of the barrier layer (typically 40 nanometers or less).

The surface roughness of a paper layer, as used herein, is the average value of the difference between the peaks and valleys found on the surface of the paper layer. The most accurate method of calculating the surface roughness for a paper layer is by using an atomic force microscope. In a preferred embodiment, the atomic force microscope reads the paper surface topography and calculates the surface roughness using the root mean square method. Atomic force microscopes are most effective when the surface roughness is less than about 100 nanometers. An optical microscope or scanning electron microscope can be employed when the roughness is greater than about 100 nanometers. Roughness measurements using the root mean square method can be made using the images taken with these microscopes.

The inventors herein have determined that an effective barrier layer can be applied to a paper substrate if the surface of the paper is smoothed before the barrier layer is applied. In one embodiment, a paper layer that comprises a surface roughness greater than the desired thickness of the barrier layer being applied to that surface is smoothed to produce a surface roughness that is less than the desired thickness of the barrier layer. In a preferred embodiment, the surface roughness on the smoothed paper is less than half the desired thickness of the barrier layer.

One method that can be used to smooth one surface of a paper substrate is to fill the valleys on the paper surface with a filler. Examples of fillers that can be applied to the paper include chalky clays, such as kaolinite, talc, mica, mordenite, vermiculite, and titanium dioxide and calcium carbonate. The filler can be bound to the paper surface using natural or synthetic binders, such as starches or latex. The filler may also contain dispersants or polymer resins. No matter how the filler is applied to the paper surface, the resulting paper has a smoother surface than the paper had prior to the application of the filler. The filler may also act as a primer layer, helping bind the barrier layer to the smooth surface of the paper.

In a preferred embodiment, the filler is a bio-based, compostable polymer. As used herein, the term “bio-based polymer” means a polymer where at least 80% of the polymer by weight is derived from a non-petroleum feedstock. In one embodiment, up to about 20% of the bio-based polymer can comprise a conventional polymer sourced from petroleum. Examples of bio-based, compostable polymers include polylactide also known as polylactic acid (“PLA”) and polyhydroxy-alkanoate (“PHA”).

PLA can be made from plant-based feedstocks including soybeans, as illustrated by U.S. Patent Application Publication Number 2004/0229327 or from the fermentation of agricultural by-products such as corn starch or other plant-based feedstocks such as corn, wheat, or sugar beets. PLA can be processed like most thermoplastic polymers into a film. PLA has physical properties similar to PET and has excellent clarity. PLA films are described in U.S. Pat. No. 6,207,792 and PLA resins are available from Natureworks LLC (http://www.natureworksllc.com) of Minnetonka, Minn. PLA degrades into carbon dioxide and biomass. PLA films used in accordance with the present invention are substantially insoluble in water under ambient conditions, but readily degrade under compost conditions.

PHA is available from Telles, a joint venture of Archer Daniels Midland of Decatur, Ill. and Metabolix of Cambridge, Mass. PHA is a polymer belonging to the polyesters class and can be produced by microorganisms (e.g. Alcaligenes eutrophus) as a form of energy storage. In one embodiment, microbial biosynthesis of PHA starts with the condensation of two molecules of acetyl-CoA to give acetoacetyl-CoA which is subsequently reduced to hydroxybutyryl-CoA. Hydroxybutyryl-CoA is then used as a monomer to polymerize PHB, the most common type of PHA.

In one embodiment, any polymer or polymer blend that processes similar to the bio-based film on an orientation line, that has a relatively smooth surface (such as provided by an amorphous PET v. a crystalline PET, described in more detail below) and that has polar chemical groups, can be used as a suitable filler. Polar chemical groups are desirable in the filler because they are attracted to the metal or metalloid barrier layer, and it is believed that polar chemical groups such as hydroxyl groups covalently bond to form a metal oxide or metalloid oxide upon metalization. Consequently, alcohol blends using an ethylene vinyl alcohol (“EVOH”) formula and polyvinyl alcohol (“PVOH”) are desirable, as are polymers having polar amide groups such as nylon. Further, amorphous PET and polyglycolic acid (“PGA”) having polar carbonyl groups can also be used. Consequently, in one embodiment, the filler comprises one or more polar films selected from amorphous PET, PGA, various nylons including amorphous nylon, EVOH, nylon/EVOH blends, PVOH, PVOH/ethylene acrylic acid (hereinafter “EAA”) blends, PVDC and a primer.

In one embodiment, the filler comprises an amorphous or glassy PET. As used herein, the terms amorphous PET and glassy PET are synonymous and defined as a PET having Tg of about 80° C. In one embodiment, amorphous PET is PET that is less than about 75% crystalline in nature. The determination of crystallinity is well known in the art and can be performed with differential scanning calorimetry (DSC) in accordance with ASTM D3418 (melting points) or ASTM E1356 (Tg). Because amorphous PET has a much smoother outer bonding surface than crystalline PET, and because the oxygen bearing groups are randomly distributed at the surface, amorphous PET provides a much better bonding surface than crystalline PET for metals such as aluminum. Further, crystalline PET has a much higher melting point and does not process in an efficient manner with PLA on an orientation line.

In one embodiment, the filler does not function as an adhesion layer. In this embodiment, a primer layer is extrusion coated over the smooth surface of the paper before the barrier layer is applied. As used herein, a primer is defined as any suitable coating that has polar chemical groups and also functions as a surface modifier that provides a smooth surface for a barrier layer 118. Examples of suitable primers that can be used in accordance with various embodiments of the present invention include, but are not limited to, an epoxy, maleic anhydride, ethylenemethacrylate (“EMA”), polyethylenimine (PEI) and ethylenevinylacetate (“EVA”).

In one embodiment, the primer layer 116 comprises an EVOH formula that can range from a low hydrolysis EVOH to a high hydrolysis EVOH. Below depicts EVOH formulas in accordance with various embodiments of the present invention.

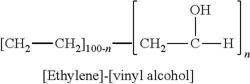

As used herein a low hydrolysis EVOH corresponds to the above formula wherein n=25. As used herein, a high hydrolysis EVOH corresponds to the above formula wherein n=80. High hydrolysis EVOH provides oxygen barrier properties but is more difficult to process. The primer layer 116 comprising the EVOH formula can be extrusion coated onto the smooth paper surface, and the barrier layer 118 can be applied by methods known in the art and listed above.

In one embodiment, the primer layer 116 comprises a PVOH coating that is applied to filler side of the paper as a liquid and then dried. A barrier layer 118 can then be applied to the primer layer 116 comprising the dried PVOH coating.

In one embodiment, the primer layer 116 is applied as a solution comprising EAA and PVOH that is coated onto smooth paper surface as a liquid and then dried. For example, the solution can comprise 0.1-20% PVOH and EAA and 80-99.9% water. In one embodiment, roughly equal amounts of PVOH and EAA are used. In one embodiment, the solution comprises about 90% water, about 5% PVOH, and about 5% EAA. Such process provides an even primer coat for a barrier layer 118.

An optional heat seal layer 120 can also be provided. In one embodiment, the heat seal layer 419 comprises an amorphous PLA, such as a 4060 PLA layer available from NATUREWORKS.

An optional ink layer can be printed on the side of the paper layer opposite the filler and primer layers. The ink layer can comprise a product logo, graphics, nutritional information, or other printed materials.

The present invention advantageously reduces consumption of fossil fuels where paper, and especially post-consumer recycled paper, is being used as a packaging film yet maintains acceptable moisture and oxygen barrier properties.

In the embodiment of the present invention that utilizes bio-based or compostable (defined by ASTM D6400) polymers as filler, primer, and/or heat seal layer, the present invention allows the paper layer be more environmentally friendly because the paper can either be composted or recycled. When the paper is composted, both the paper and the bio-based polymer will break down under compost conditions. Furthermore, the paper is also more suitable for use in typical paper recycling processes, for reasons described below.

Most paper is recycled by mechanical re-pulping. Polymers that are compatible with recycling must be compatible with the mechanical re-pulping process. Paper may also undergo chemical re-pulping processes prior to mechanical re-pulping, which employs caustic soda (NaOH), bleaching agents, or other chemicals to dissolve or otherwise remove contaminates or polymer coating from the paper surface.

When polyethylene or polypropylene is coated onto a paper surface, the polymers bind to the paper fibers and when separated out by mechanical re-pulping processes, result in loss of paper fiber over 15% by weight. The polymer sticks to and takes some of the paper fiber with it as a waste stream during the re-pulping process. Most paper mills will refuse to take polymer coated paper as recycle for this reason.

The caustic wash of the re-pulping process will not degrade polyethylene and other polyolefins due to their high chemical resistance. However, PHA, PLA and other bio-based polymers are made under aqueous condensation polymerization conditions, which leave the chemical linkages between polymers vulnerable to chemical attack by NaOH and other agents. The PLA and PHA polymerization result in water molecules being ejected, and this is a reversible reaction. Therefore, water, heat (to provide energy), and chemical agents (NaOH) will all help to remove the polymer or at least reduce fiber loss compared with polyethylene and polypropylene. Hydrolysis (possibility aided by NaOH) will help to break down the polymers.

Some compostable polymers which are not renewably resourced may also be used with the present invention, such as aliphatic polyesters that contain linkages which are biologically accessible.

In one embodiment, the present invention reduces the amount of materials required to provide a paper-based film with barrier properties. When the filler also functions as the primer layer, only three layers are required to impart adequate barrier properties to the paper.

As used herein, the term “package” should be understood to include any container including, but not limited to, any food container made up of flexible multi-layer packaging films. The packaging materials discussed herein are particularly suitable for forming flexible packages for snack foods such as potato chips, corn chips, tortilla chips and the like. However, while the layers and films discussed herein are contemplated for use in processes for the packaging of snack foods, such as the filling and sealing of bags of snack foods, the layers and films can also be put to use in processes for the packaging of other low moisture products.

Unless otherwise defined, all technical and scientific terms used herein have the same meaning as commonly understood by one of ordinary skill in the art to which this invention belongs. All references cited herein are incorporated by reference; however, in case such references conflict with the present disclosure, including references within the priority documents, the present disclosure controls. While this invention has been particularly shown and described with reference to a preferred embodiment, it will be understood by those skilled in the art that various changes in form and detail may be made therein without departing from the spirit and scope of the invention.

What is claimed is:

1. A multi-layer packaging film comprising a paper layer having at least one surface smoothed by a filler layer, an optional primer layer on said at least one smoothed surface, a barrier layer on said at least one smoothed surface or said optional primer layer, and an optional heat seal layer on said barrier layer.

2. The film of claim 1 wherein said filler is chosen from the group consisting of kaolinite, talc, mica, mordenite, vermiculite, titanium dioxide and calcium carbonate.

3. The film of claim 2 wherein said filler further comprises a binder.

4. The film of claim 1 wherein said barrier layer comprises a thickness, said paper layer comprises a surface roughness when measured without said filler layer, wherein said surface roughness is greater than said barrier layer thickness.

5. The film of claim 1 wherein said filler comprises a polymer that comprises polar chemical groups.

6. The film of claim 1 wherein said filler comprises a bio-based, compostable polymer.

7. The film of claim 1 wherein all polymers used in said film comprise at least one bio-based, compostable polymer.

8. The film of claim 1 wherein said primer layer comprises a polymer chosen from the group consisting of epoxy, maleic anhydride, ethylenemethacrylate, and ethylenevinylacetate, polyvinyl alcohol, polyethylenimine, polyvinylidene chloride and ethylvinyl alcohol.

9. The film of claim 1 wherein said filler comprises amorphous or glassy polyethylene.

10. The film of claim 7 wherein said bio-based, compostable polymer is at least one of polylactic acid and polyhydroxy-alkanoate.

11. A method for making a paper-based barrier film, said method comprising the steps of:
smoothing a product side surface of a paper layer to provide a smoothed surface;
applying a barrier layer to said smoothed surface.

12. The method of claim 11 wherein said smoothing comprises applying a filler to said product side surface.

13. The method of claim 12 wherein said smoothing comprises applying a primer layer over said filler.

14. The method of claim 11 further comprising applying a heat seal layer to said barrier layer.

15. The method of claim 11 wherein said barrier layer comprises a thickness, and wherein said product side surface comprises a first surface roughness prior to said smoothing step which is greater than said barrier layer thickness, and a second surface roughness after said smoothing step which is less than said barrier layer thickness.

16. The method of claim 11 wherein said applying said barrier layer comprises applying a barrier layer comprising at least one of a metal, a metal oxide, or a metalloid oxide.

17. The method of claim 11 wherein said applying said barrier layer comprising coating said smoothed surface with at least one of polyvinylidene chloride, ethylene vinyl alcohol, polyvinyl alcohol, or acrylics.
